(19) United States
(12) Patent Application Publication
(10) Pub. No.: US 2014/0009908 A1
(43) Pub. Date: Jan. 9, 2014

(54) BACKLIGHT MODULE WITH LIGHT SCATTERING PLATE

(71) Applicant: CHING-HAO CHAO, Tu-Cheng (TW)

(72) Inventor: CHING-HAO CHAO, Tu-Cheng (TW)

(21) Appl. No.: 13/661,129

(22) Filed: Oct. 26, 2012

(30) Foreign Application Priority Data
Jul. 6, 2012 (TW) 101124473

(51) Int. Cl. G09F 13/04

(52) U.S. Cl. 362/97.1

(57) ABSTRACT

A backlight module includes a light source and a light scattering plate. The light scattering plate includes a light incident surface and a light output surface, the light incident surface facing the light source, and the light output surface defining a number of netted dots for scattering light. A distribution of the netted dots meets formulas of rₖ=ak^{b} and θₖ=2πφ⁻², wherein k is an ordinal number of one netted dot, rₖ is a distance between the k netted dot and the a center of the light source, and θₖ is an angle of the k netted dot relative to a center of the light source, a>0, b>0 and

$$ϕ = \frac{1 + \sqrt{5}}{2} .$$

### BACKGROUND

1. Technical Field

The present disclosure relates to backlight modules, and particularly to a backlight module having a light scattering plate.

2. Description of Related Art

Backlight modules, including direct type backlight modules and side type backlight modules, usually use light scattering plates defining netted dots for scattering light.

A typical light scattering plate has netted dots distributed freely, however, in this way, some of the netted dots will be sheltered by another, such that a work efficiency of the netted dots is lowered, and light on a light output surface of the light scattering plate is not uniform.

What is needed, therefore, is a backlight module, which can overcome the above shortcomings

### BRIEF DESCRIPTION OF THE DRAWINGS

Many aspects of the present backlight module can be better understood with reference to the following drawings. The components in the drawings are not necessarily drawn to scale, the emphasis instead being placed upon clearly illustrating the principles of the present backlight module. Moreover, in the drawings, like reference numerals designate corresponding parts throughout the several views.

FIG. 1 is schematic cross sectional view of a backlight module in accordance with one embodiment, the backlight module including a light scattering plate defining netted dots on a light output surface thereof.

FIG. 2 is a first distribution of the netted dots of FIG. 1 in accordance with a first embodiment.

FIG. 3 is a second distribution of the netted dots of FIG. 1 in accordance with a second embodiment.

FIG. 4 is a third distribution of the netted dots of FIG. 1 in accordance with a third embodiment.

FIG. 5 is a fourth distribution of the netted dots of FIG. 1 in accordance with a fourth embodiment.

FIG. 6 is a fifth distribution of the netted dots of FIG. 1 in accordance with a fifth embodiment.

### DETAILED DESCRIPTION

Embodiments of the present disclosure will now be described in detail below and with reference to the drawings.

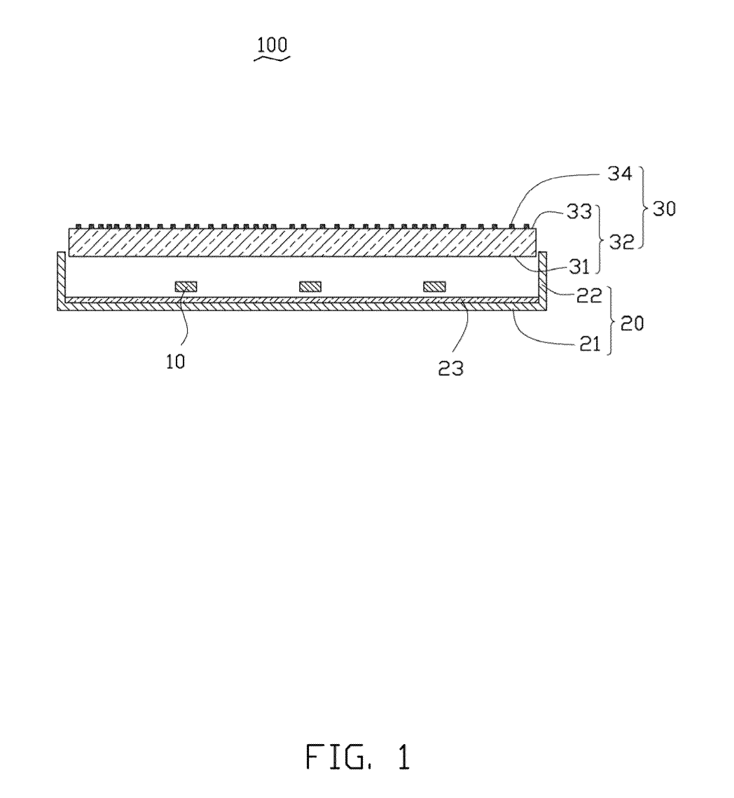

FIG. 1 shows a backlight module 100 in accordance with one embodiment. The backlight module 100 includes a light source 10, a reflecting cover 20 receiving the light source 10, and a light scattering plate 30.

In the present embodiment, the light source 10 includes a number of LEDs. In other embodiments, the light source 10 can be one or more lamps, for example, lamps in W shape.

The reflecting cover 20 includes a bottom wall 21 and four side walls 22. The reflecting cover 20 has a reflecting coating formed on the side walls 22, and configured for reflecting light emitted from the light source 10 to the light scattering plate 30. A reflecting plate 23 is placed on the bottom wall 21 for reflecting light to the light scattering plate 30.

The light scattering plate 30 includes a transparent main body 32 and a plurality of netted dots 34 formed on the main body 32. The main body 32 contains at least one material of polymethyl methacrylate (PMMA) and polycarbonate (PC). The main body 32 includes a light incident surface 31 and a light output surface 33. The light incident surface 31 faces the light source 10. The netted dots 34 are defined on the light output surface 33. When light transmits through the main body 32 from the light incident surface 31 to the light output surface 33, the netted dots 34 can scatter the light to be uniform on the light output surface 33. The main body 32 can have or be free of light scattering particles inside the main body 32.

In the present embodiment, the light incident surface 31 is parallel with the light output surface 33, i.e., the backlight module 100 is a direct type backlight module. In other embodiments, the light incident surface can be perpendicular to the light output surface 33, i.e., the backlight module 100 is a side type backlight module.

The netted dots 34 can be printed on the light output surface 33, etched in the light output surface 33, or integrally formed with the main body 32. That is, the netted dots 34 can be concave portions in the light output surface 33, or can be protrusions on the light output surface 33. Each of the netted dots 34 can be round or in other shapes. A size of each of the netted dots 34 may be in a range of 40˜300 μm. Preferably, the netted dots 34 are even in size .

The netted dots 34 cooperatively form a Fermat's spiral shape, which meets the following formulas of rₖ=ak^{b} and θₖ=2πφ⁻²k, wherein, k is an ordinal number of one netted dot, rₖ is a distance between the k netted dot and the a center of the light source 10, and θₖ is an angle of the k netted dot relative to a center of the light source 10, a>0, b>0 and

$$ϕ = \frac{1 + \sqrt{5}}{2} .$$

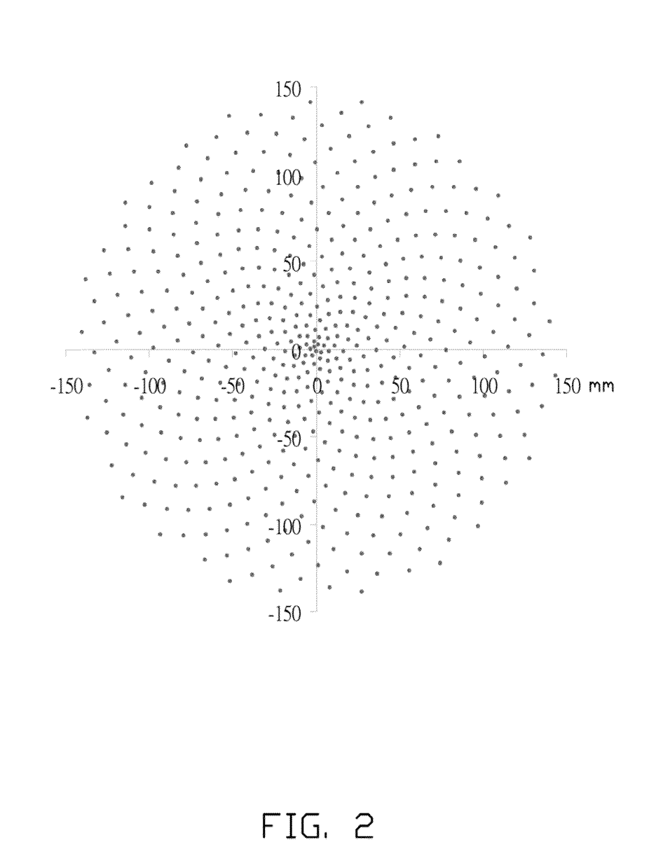

FIG. 2 shows a netted dot distribution when a=1 and b=0.8.

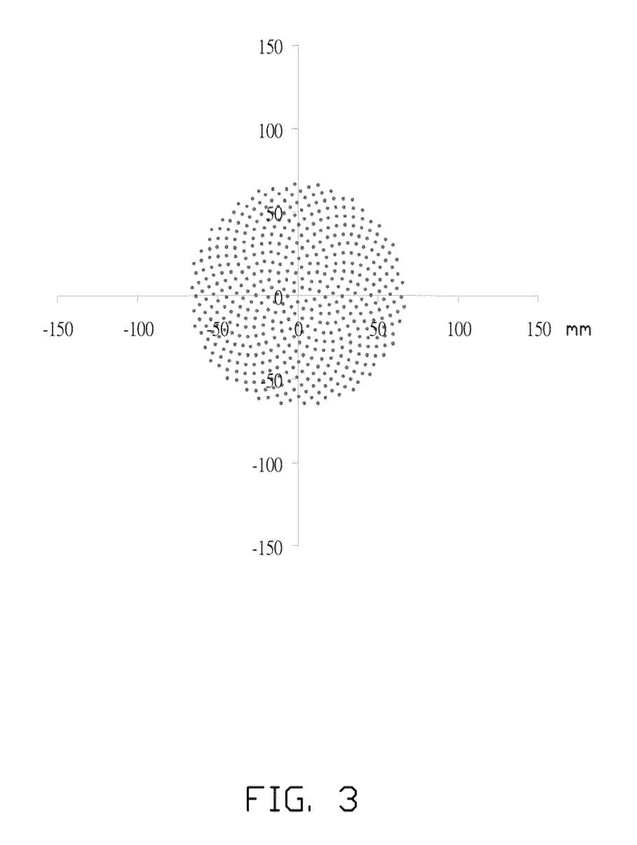

FIG. 3 shows a netted dot distribution when a=3 and b=0.5.

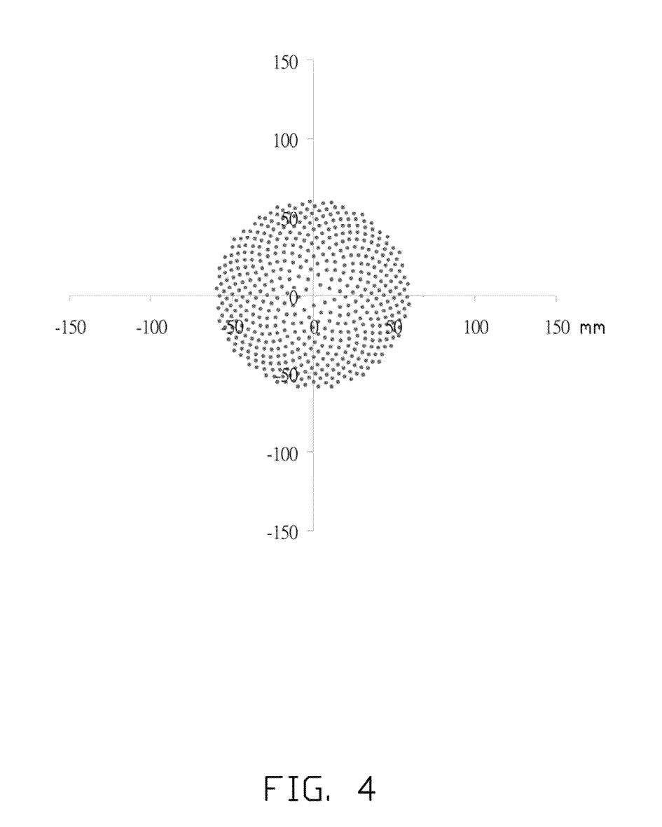

FIG. 4 shows a netted dot distribution when a=5 and b=0.4.

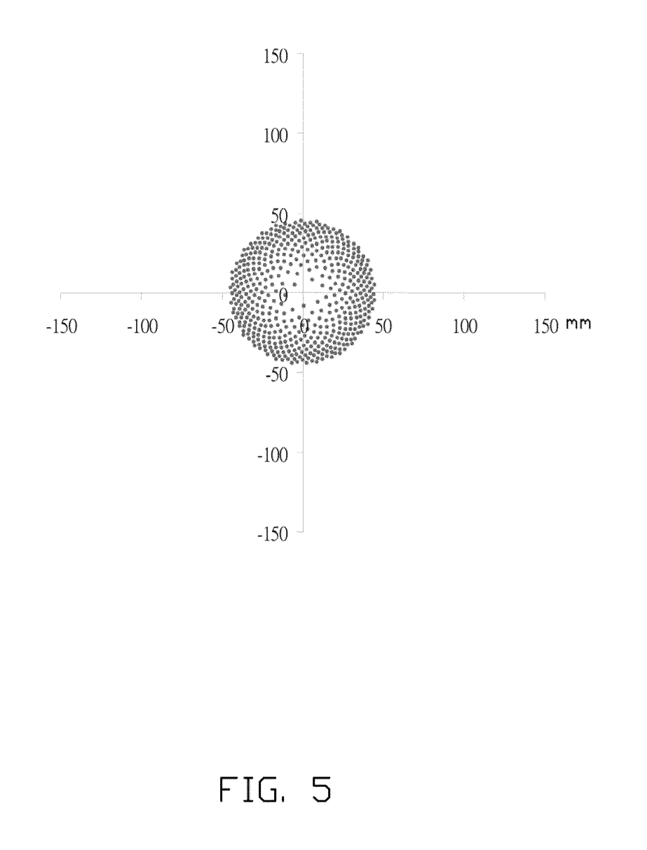

FIG. 5 shows a netted dot distribution when a=7 and b=0.3.

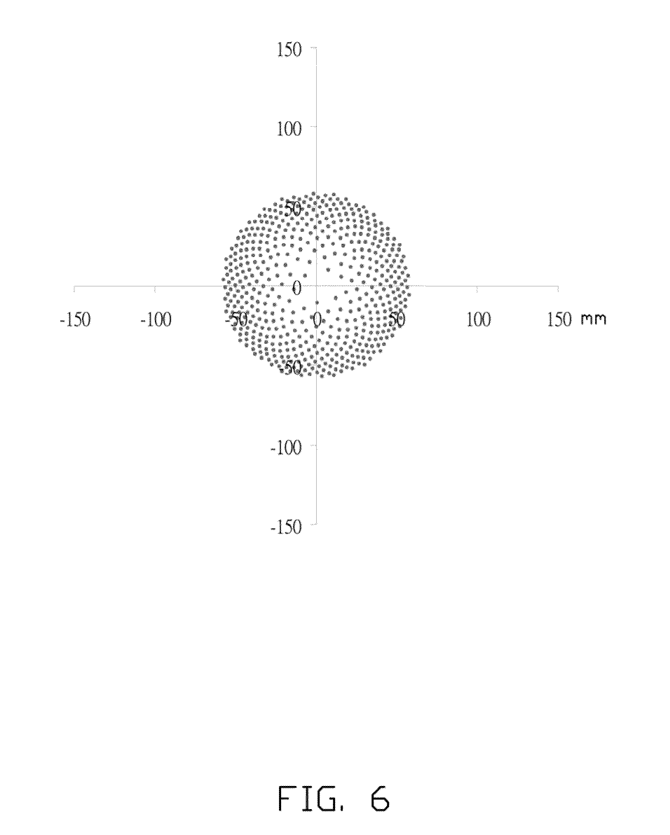

FIG. 6 shows a netted dot distribution when a=9 and b=0.3.

In the above figures, the distributions are different, but each of the distributions belongs to the Fermat's spiral. Such distributions of the netted dots 34 can be applicable according to need, for example, when a light source is big in size, the netted dots 34 closer to the center can be less than the netted dots 34 away from the center, such that the light on the light output surface 33 will be more uniform.

The Fermat's spiral appears in various natural plants, such as petals of sunflower which can avoid adjacent petals to be sheltered by each other. In the present embodiment, adjacent netted dots 34 can be avoided to be sheltered by each other, such that work efficiency of each of the netted dots 34 is improved, and thereby making full use of each area of the light scattering plate 30.

The center of the light source 10 can be a geometric center of the light source 10, including a geometric center of the LEDs.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A backlight module, comprising:
a light source; and
a light scattering plate comprising a light incident surface and a light output surface, the light incident surface facing the light source, and the light output surface defining a plurality of netted dots for scattering light, wherein a distribution of the netted dots meets the following formulas rₖ=ak^{b} and θₖ=2πφ⁻²k, k is an ordinal number of one netted dot, rₖ is a distance between the k netted dot and the a center of the light source, and θₖ is an angle of the k netted dot relative to a center of the light source, a>0, b>0 and
$$ϕ = \frac{1 + \sqrt{5}}{2} .$$

2. The backlight module of claim 1, wherein the light source comprises a plurality of LEDs.

3. The backlight module of claim 1, further comprising a reflecting cover receiving the light source therein and configured for reflecting light to the light scattering plate.

4. The backlight module of claim 2, further comprising a reflecting plate placed on a bottom of the reflecting cover for reflecting the light to the light scattering plate.

5. The backlight module of claim 1, wherein the light incident surface is parallel with the light output surface.

6. The backlight module of claim 1, wherein the light incident surface is perpendicular to the light output surface.

7. The backlight module of claim 1, wherein the netted dots cooperatively form a Fermat's spiral.
